(19) United States
(12) Patent Application Publication
(10) Pub. No.: US 2012/0115024 A1
(43) Pub. Date: May 10, 2012

(54) CATHODE ELECTRODE FOR LITHIUM-ION SECONDARY BATTERY AND LITHIUM-ION SECONDARY BATTERY USING THE SAME

(76) Inventors: Zhi CHEN, Dongguan (CN); Ying WANG, Dongguan (CN); Fenggang ZHAO, Dongguan (CN); Zilong YU, Dongguan (CN); Yuansen XIE, Dongguan (CN); Jianxun XIE, Dongguan (CN); Jiajai HU, Dongguan (CN); Leimin XU, Dongguan (CN)

(21) Appl. No.: 13/086,570

(22) Filed: Apr. 14, 2011

(30) Foreign Application Priority Data
Nov. 5, 2010 (CN) 201010535267.2

(51) Int. Cl. H01M 2/08; H01M 4/64

(52) U.S. Cl. 429/185; 429/211

(57) ABSTRACT

A cathode electrode for lithium-ion secondary battery includes a current collector; and a cathode material layer comprising a bottom layer coated on the current collector and a top layer coated on the bottom layer. The lithium-ion transfer resistance of the active material particles in the bottom layer is smaller than that of the active material particles in the top layer, optimize the concentration polarization occurred in the cathode electrode during discharge, and enabling the lithium-ion secondary battery using the cathode electrode to be improved both in energy density and safety, and be further enhanced in specific capacity.

### TECHNICAL FIELD

The present invention relates to the field of lithium-ion secondary batteries. More particularly, the present invention relates to double-layer cathode electrode consisted of a cathode inner layer with a modified cathode outer layer.

### BACKGROUND ART

Lithium-ion secondary batteries have been widely used in various industries due to their advantages of high specific capacity, high operating voltage, broad temperature range, low self-discharge rate, long cycle characteristics life, cleanness and light weight.

A lithium-ion secondary battery generally comprises a cathode electrode, an anode electrode, a separator membrane disposed between the cathode electrode and the anode electrode, and electrolyte. The cathode comprises a current collector, and a cathode film attached on the current collector. The anode comprises current collector, and an anode film attached on the anode current collector. The separator membrane is disposed between the cathode electrode and the anode electrode, serving as an electron barrier and preventing a short circuit between the cathode electrode and the anode electrode. The electrolytes are absorbed by the cathode electrode, the anode electrode and the separator membrane to form a lithium-ion pathway. During the normal operation of the lithium-ion secondary battery, an electron pathway, which is form by the cathode end from the cathode current collector, the anode end from the anode current collector and an external circuit, and an ion pathway, which is formed by the electrolytes and the lithium ions in the active materials of the cathode, jointly form a return circuit for normal operation.

With the increasing demands for lithium-ion secondary battery, the requirements for various performances thereof, especially for safety, is becoming higher and higher. How to improve the safety of a lithium-ion secondary battery has become a focus of research; and the requirement for high energy density and cycle characteristics counts while pursuing safety is become higher and higher. A variety of solutions have been proposed in the prior art for improving the safety of lithium-ion secondary battery. Regarding the cathode using double-layer films, a method for improving the safety of a lithium-ion secondary battery was revealed, for example, in Journal of The Electrochemical Society, 2007: 154(5) A412-A416, in which a layer of lithium iron phosphate active material was firstly coated on a current collector as a bottom layer, and then a layer of lithium cobalt oxide active material was coated on the lithium iron phosphate, to form a cathode with double-layer film. In deed, the solution adopting double-layer film cathode can enhance the safety of lithium-ion secondary battery, and improve the overcharging performance of the lithium-ion secondary battery. However, since the voltage level of lithium iron phosphate is lower than that of lithium cobalt oxide active material, the low mixed voltage level in the double-layer films results in small energy density, and reduced specific capacity of active materials as compared to that in the prior art.

Secondly, a double-layer film cathode was adopted, for example, in CN101471435A, in which a cathode for lithium-ion secondary battery was disclosed, comprising a current collector, a coating layer coated on the current collector, and a cathode material layer, wherein the coating layer was positioned between the current collector and the cathode material layer, and contained cathode active material, positive temperature coefficient material, and a binder. The rechargeable lithium battery prepared by using the cathode is characterized by sensitive response to overcharge, heat, and short circuit, and can meet a safety need. It is obvious that substituting active materials by the positive temperature coefficient material of the bottom layer decreased the energy density of the whole cathode electrode. In addition, there is no improvement in specific capacity of active materials mentioned in the above patent.

The merely use of coating material was adopted, for example in CN1319192C, in which a lithium-ion battery utilizing cathode material with surface coating was disclosed. The obtained lithium-ion battery has better high-temperature behavior, stable cycle characteristics, and good anti-overcharge. However, the mere use of coating material can neither improve the specific capacity under the same charge state, nor change low-temperature performance.

At present, it is very difficult for conventional lithium-ion secondary battery which adopts either multiple-layer cathode film or normal film (specifically referring to single-layer cathode film) to improve both safety and energy density. Moreover, the specific capacity of the active material substantially reaches a threshold level. The reason lies in that, in a cathode electrode using a single-layer cathode electrode, due to the same active material, the active material far from the collector is closer to the cathode and thus can receive lithium ions transported from the cathode more easily than the inner active material (near the current collector), which can only receive a small amount of lithium ions transported from the cathode. Moreover, this phenomenon becomes obvious with the increasing of the discharge rate. the phenomenon of concentration polarization also exist in a cathode electrode coated with active materials that are surface coated with metal oxides. The key to such problem lies in how to reduce the concentration polarization during lithium insertion process.

### SUMMARY OF THE INVENTION

The object of the present invention is to address the problem of concentration polarization occurred in a cathode electrode during discharge by providing a cathode electrode for lithium-ion secondary battery, and a lithium secondary battery using the same, which can achieve improved both energy density and safety, as well as enhanced specific capacity.

The following technical solution is adopted to achieve the above object:

A cathode electrode for lithium-ion secondary battery, comprising: a current collector; and a cathode material layer which comprises a bottom layer coated on the current collector; and a top layer coated on the bottom layer, wherein the lithium-ion transfer resistance of the active material particles in the bottom layer is smaller than that of the active material particles in the top layer. Compared with the prior art, the cathode electrode according to the present invention adopts a top layer, and a bottom layer which has the same kind of active materials as in the top layer, but has a lithium-ion transfer resistance smaller than that of the active material in the top layer. Therefore, the active material particles in the top layer has a relatively large lithium-ion transfer resistance, so that during discharge the active materials in the top layer receive less lithium ions than those in the prior art; and the active material particles in the bottom layer has relatively small lithium-ion transfer resistance, so that during discharge the bottom layer receive more lithium ions than those in the prior art, thereby weakening the concentration polarization occurred in the cathode electrode during small rate discharge. Correspondingly, the lithium-ion secondary battery using the aforementioned cathode electrode can achieve improved energy density, and further enhanced specific capacity. When the discharge current is increased to a large one, such as the internal short happens, the amount of lithium ions inserted into the cathode per unit time sharply increase. However, on one hand, it is difficult for the lithium ions to be inserted since the active material particles has a relatively large lithium-ion transfer resistance; and on the other hand, the lithium ions can not be completely inserted into the bottom layer since they have not yet reach the bottom layer, leading to a cut-off voltage and small amount of discharge, and in turn a large improvement in safety for the lithium-ion secondary battery.

In the above battery, the active material in the top layer and the active material in the bottom layer are of the same kind.

In the above battery, the bottom layer is consisted of an active material, a conductive carbon, and a binder, wherein the active material is surface coated with a coating material; and the top layer is consisted of an active material, a conductive carbon, and a binder, wherein the active material is surface coated with a coating material different from that for the active material in the bottom layer.

In the above battery, the active material in the bottom layer is surface coated with 0.01%-5% zirconia by mass percentage; and the active substance in the top is surface coated with one or more of aluminium oxide, magnesium oxide, zinc oxide, and manganese dioxide by a mass percentage of 0.01%-5%.

In the above battery, both the active material in the top layer and the active material of the bottom layer are surface coated with the same cladding material, and the mass percentage of the cladding material for the top layer is larger that that of the cladding material for the bottom layer.

In the above battery, the cladding material is one or more of aluminium oxide, magnesium oxide, zinc oxide, and manganese dioxide, wherein the mass percentage of the cladding material for the top layer is 0.02%-10%, and the mass percentage of the cladding material for the bottom layer is 0.01%-5%.

In the above battery, the active material in the bottom layer is not surface coated with a metal oxide, and the active material in the top layer is surface coated with metal oxides which are one or more of aluminium oxide, magnesium oxide, zinc oxide, and manganese dioxide, wherein the cladding material for the top layer has a mass percentage of 0.01%-10%.

In the above battery, the active material in the bottom layer is surface coated with 0.05% zirconium oxide by mass percentage; and the active material in the top layer is surface coated with 0.6% aluminum oxide by mass percentage.

In the above battery, the bottom layer has a thickness of 5-105 microns, and the top layer has a thickness of 5-105 microns.

The present invention further provides a lithium-ion secondary batter, comprising a battery container, a electrode assembly, and an electrolyte, wherein the electrode assembly and the electrolyte are sealed in the battery container, and the electrode assembly comprises a cathode, an anode and a separator membrane disposed between the cathode and the anode, wherein the cathode is the above cathode electrode for lithium-ion secondary battery, which can achieve improved both energy density and safety, as well as enhanced specific capacity.

### DETAILED DESCRIPTION OF THE EMBODIMENTS

The lithium-ion secondary battery and the cathode electrode thereof according to the present invention will be described in detail in combination with the following examples. However, the examples of the present invention are not limited thereto.

### Example 1

The manufacturing of the cathode electrode: cathode active material which is lithium Cobalt oxide (LiCoO2), a electronic conducting agency which is carbon black, a binder which is polyvinylidene fluoride (PVDF) and a solvent which is N-methyl pyrrolidone (NMP) were homogeneously mixed at a weight ratio of 95:2:3:80 to provide a bottom layer slurry to be coated; the bottom layer slurry was uniformly coated on a 14 micron-thick aluminum foil current collector by s coating thickness of about 55 microns, and then dried at 110° C. to provide a bottom layer film; a top layer slurry prepared by homogeneously mixed cathode active material lithium Cobalt oxide (LiCoO2) surface coated with 0.6% aluminum oxide by mass percentage, carbon black, polyvinylidene fluoride (PVDF) and N-methyl pyrrolidone (NMP) at a weight ratio of 95:2:3:80 was uniformly coated on the above dried bottom layer film by a thickness of about 55 microns, and then dried at 110° C. to provide a top layer film. Thus, a cathode electrode having double-layer film was prepared.

The manufacturing of the anode electrode: anode active material which is artificial graphite, a electronic conducting agency which is carbon black, a binder which is carboxymethylcellulose (CMC) and styrene butadiene rubber(SBR) and a solvent which is water were homogeneously mixed at a weight ratio of 93:2:2:3:100 to provide an anode slurry to be coated; the anode slurry was uniformly coated on a 9 micron-thick copper foil current collector by a coating thickness of about 100 microns, and then dried at 100° C. to provide an anode electrode.

The manufacturing a lithium-ion secondary battery: the cathode electrode and the anode electrode prepared according the above processes and PP/PE/PP separator memberance which was set between the cathode electrode and anode electrode were rolled or laminated into a battery core, which was placed into a battery container, injected with electrolyes and sealed to give a lithium-ion secondary battery having 4.5 mm thickness, 43 mm wideness, and 60 mm length. In the battery, the electrolyte uses 1 mol/l lithium hexafluorophosphate (LiPF6) as the lithium salt, and the mixture of ethylene carbonate (EC), polycarbonate (PC) and dimethyl carbonate (DMC) in a weight ratio of 1:1:1 as the solvent.

### Example 2

The cathode electrode and the anode electrode was manufactured in a procedure substantially the same as in example 1, except that the active material lithium cobalt oxide in the bottom layer film of the cathode electrode in example 2 was surface coated with 0.01% zirconium oxide by a weight percentage.

### Example 3

The cathode electrode and the anode electrode was manufactured in a procedure substantially the same as in example 1, except that the active material lithium cobalt oxide in the bottom layer film of the cathode electrode in example 3 was surface coated with 5% zirconium oxide by a weight percentage.

### Example 4

The cathode electrode and the anode electrode was manufactured in a procedure substantially the same as in example 1, except that the active material lithium cobalt oxide in the bottom layer film of the cathode electrode in example 4 was surface coated with 0.05% aluminum oxide by a weight percentage.

### Example 5

The cathode electrode and the anode electrode was manufactured in a procedure substantially the same as in example 1, except that the active material lithium cobalt oxide in the top layer film of the cathode electrode in example 5 was surface coated with 0.6% magnesium oxide by a weight percentage.

### Example 6

The cathode electrode and the anode electrode was manufactured in a procedure substantially the same as in example 1, except that the active material lithium cobalt oxide in the bottom layer film of the cathode electrode in example 6 was surface coated with 0.01% aluminum oxide by a weight percentage.

### Example 7

The cathode electrode and the anode electrode was manufactured in a procedure substantially the same as in example 1, except that the active material lithium cobalt oxide in the bottom layer film of the cathode electrode in example 7 was surface coated with 1% aluminum oxide by a weight percentage, and the active material lithium cobalt oxide in the top layer film of the cathode electrode was surface coated with 5% aluminum oxide by a weight percentage.

### Example 8

The cathode electrode and the anode electrode was manufactured in a procedure substantially the same as in example 1, except that the active material lithium cobalt oxide in the top layer film of the cathode electrode in example 8 was surface coated with 10% aluminum oxide by a weight percentage.

### Example 9

The cathode electrode and the anode electrode was manufactured in a procedure substantially the same as in example 1, except that the thickness of the bottom layer film of the cathode electrode in example 9 was 5 microns, and that of the top layer film of the cathode was 105 microns.

### Example 10

The cathode electrode and the anode electrode was manufactured in a procedure substantially the same as in example 1, except that the thickness of the bottom layer film of the cathode electrode in example 10 was 105 microns, and that of the top layer film of the cathode was 5 microns.

### Example 11

The cathode electrode and the anode electrode was manufactured in a procedure substantially the same as in example 1, except that the thickness of the bottom layer film of the cathode electrode in example 11 was 20 microns, and that of the top layer film of the cathode was 90 microns.

### Example 12

The cathode electrode and the anode electrode was manufactured in a procedure substantially the same as in example 1, except that the thickness of the bottom layer film of the cathode electrode in example 12 was 40 microns, and that of the top layer film of the cathode was 70 microns.

### Example 13

The cathode electrode and the anode electrode was manufactured in a procedure substantially the same as in example 1, except that the active material used in example 13 is NCA material which is subject to the same cladding treating as in example 1.

### Comparative Example 1

The manufacturing of the cathode electrode: cathode active material which is lithium cobalt oxide (LiCoO2), a electronic conducting agency which is carbon black, a binder which is polyvinylidene fluoride (PVDF) and a solvent which is N-methyl pyrrolidone (NMP) were homogeneously mixed at a weight ratio of 95:2:3:80 to provide a slurry to be coated; the slurry was uniformly coated on a 14 micron-thick aluminum foil current collector by s coating thickness of about 110 microns, and then dried at 110° C. to provide a cathode film layer.

The manufacturing of the anode electrode: anode active material which is artificial graphite, a electronic conducting agency which is carbon black, a binder which is carboxymethylcellulose (CMC) and styrene butadiene rubber(SBR) and a solvent which is water were homogeneously mixed at a weight ratio of 93:2:2:3:100 to provide an anode slurry to be coated; the anode slurry was uniformly coated on a 9 micron-thick copper foil current collector by a coating thickness of about 100 microns, and then dried at 100° C. to provide an anode electrode.

The manufacturing a lithium-ion secondary battery: the cathde palte and the anode electrode prepared according the above processes and PP/PE/PP separator memberance which was set between the cathode electrode and anode electrode were rolled or laminated into a battery core, which was placed into a battery container, injected with electrolyes and sealed to give a lithium-ion secondary battery having 4.5 mm thickness, 43 mm wideness, and 60 mm length. In the battery, the electrolyte uses 1 mol/l lithium hexafluorophosphate (LiPF6) as the lithium salt, and the mixture of ethylene carbonate (EC), polycarbonate (PC) and dimethyl carbonate (DMC) in a weight ratio of 1:1:1 as the solvent.

### Comparative Example 2

The manufacturing of the cathode electrode: cathode active material which is NCA (or Li[NiMnCo]O₂), a electronic conducting agency which is carbon black, a binder which is polyvinylidene fluoride (PVDF) and a solvent which is N-methyl pyrrolidone (NMP) were homogeneously mixed at a weight ratio of 95:2:3:80 to provide a slurry to be coated; the slurry was uniformly coated on a 14 micron-thick aluminum foil current collector by coating thickness of about 110 microns, and then dried at 110° C. to provide a cathode film layer.

The manufacturing of the anode electrode: anode active material which is artificial graphite, a electronic conducting agency which is carbon black, a binder which is carboxymethylcellulose (CMC) and styrene butadiene rubber(SBR) and a solvent in which water were homogeneously mixed at a weight ratio of 93:2:2:3:100 to provide an anode slurry to be coated; the anode slurry was uniformly coated on a 9 micron-thick copper foil current collector by a coating thickness of about 100 microns, and then dried at 100° C. to provide an anode electrode.

The manufacturing a lithium-ion secondary battery: the cathode electrode and the anode electrode prepared according the above processes and PP/PE/PP separator memberance were rolled or laminated into a battery core, which was placed into a battery container, injected with electrolytes and sealed to give a lithium-ion secondary battery having 4.5 mm thickness, 43 mm wideness, and 60 mm length. In the battery, the electrolyte uses 1 mol/l lithium hexafluorophosphate (LiPF6) as the lithium salt, and the mixture of ethylene carbonate (EC), polycarbonate (PC) and dimethyl carbonate (DMC) in a weight ratio of 1:1:1 as the solvent.

1. Rate Test

At a testing temperature of 23±2° C., the lithium-ion secondary battery was charged at a constant current of 0.5 C to 4.2±0.01V, charged at a constant voltage to a cut-off current of 0.05 C; rested for 10 mins; than discharged at 0.2 C to a cut-off voltage of 3.0V, with the capacity being recorded as the initial capacity for the rate test. Then, the battery was charged at a constant current of 0.5 C to 4.2±0.01V, charged at a constant voltage to a cut-off current of 0.05 C; rested for 10 mins; than discharged at 1 C to a cut-off voltage of 3.0V, with the capacity being recorded as the rate capacity for 1 C. then, the battery was charged at a constant current of 0.5 C to 4.2±0.01V, charged at a constant voltage to a cut-off current of 0.05 C; rested for 10 mins; and discharged at 3 C to a cut-off voltage of 3.0V, with the capacity being recorded as the rate capacity for 3 C.

2. Specific Capacity Test

At a test temperature of 23±2° C., the battery was charged at a constant current of 0.5 C to 4.2±0.01V, charged constantly at the voltage to a cut-off current of 0.05 C; rested for 10 mins; and discharged at 0.5 C to a cut-off voltage of 3.0V, with the capacity being recorded as the initial capacity for the specific capacity test. The formula for calculating the specific capacity is: specific capacity=0.5 C capacity/the weight of cathode active material.

3. Cycle Characteristics Life Test

At a test temperature of 23±2° C., the battery was charged at a constant current of 0.5 C to 4.2±0.01V, charged constantly at the voltage to a cut-off current of 0.05 C; rested for 10 mins; and discharged at 0.5 C to a cut-off voltage of 3.0V. the cycle characteristics was performed for 500 times, capacity was recorded, and remaining capacity ratio was calculated for each cycle characteristics. remaining capacity ratio=the capacity remained after 500 times cycle characteristics/initial capacity.

4. Nail Test

At a test temperature of 23±2° C., the prepared battery was charged at a constant current of 0.5 C to 4.2±0.01V, charged constantly at the voltage to a cut-off current of 0.05 C; rested for 15 mins; and then was subjected to a nail test at 23±2° C. An experimental steel nail of 2-mm diameter was pierced into the battery at 1 mm/s, and was stopped upon piercing through the battery. If the battery does not catch fire, explode, or jet electrolyte within the sequential 10 min, it passes the test, otherwise it fails.

The batteries prepared in each of examples and comparative examples was subjected to the above tests, and the results thus obtained were listed in the table 1 below.

TABLE 1
the results for the performance tests of each
of examples and comparative examples

| | | | Specific | Remaining | |
|---|---|---|---|---|---|
| | Rate test (%) | | capacity | capacity | |
| | 1C | 3C | (mAh/g) | rate (%) | Nail test |
| Example 1 | 96.3% | 30% | 146 | 92% | pass |
| Example 2 | 96.7% | 32% | 147 | 92% | pass |
| Example 3 | 96.2% | 30% | 146 | 91% | pass |
| Example 4 | 96.2% | 30% | 145 | 92% | pass |
| Example 5 | 96.0% | 40% | 144 | 90% | pass |
| Example 6 | 95.2% | 26% | 143 | 92% | pass |
| Example 7 | 95.7% | 36% | 145 | 91% | pass |
| Example 8 | 94.1% | 20% | 142 | 92% | pass |
| Example 9 | 95.8% | 27% | 142 | 87% | pass |
| Example 10 | 95.9% | 33% | 144 | 89% | pass |
| Example 11 | 95.3% | 20% | 143 | 89% | pass |
| Example 12 | 96.2% | 34% | 149 | 91% | pass |
| Example 13 | 96.7% | 34% | 183 | 94% | pass |
| Comparative | 93.6% | 72% | 140 | 81% | fail |
| example 1 | | | | | |
| Comparative | 94.1% | 80% | 173 | 82% | fail |
| example 2 | | | | | |

It can be seen from the results for the performance tests that: the lithium-ion secondary battery according to the present invention has the following advantages over the prior art: 1) improved capacity ratio at low rate (1 C) and lowered capacity at high rate (3 C), which meets demands for use and facilitate the safety; 2) high specific capacity; 3) good remaining capacity ratio; and 4) facilitating a nail test.

It should be noted that although the present invention is described in individual examples by taking a double-layer film cathode electrode using NCA and lithium cobalt oxide as the cathode material as an example, other embodiments according to the present invention also applies to lithium nickelate, lithium manganese oxide, lithium iron phosphate and Li (NxCoyMnz)O₂, the principle and manufacturing process of which are substantially the same as those described in the examples and are not repeated.

According to the suggestion and teaching, suitable change and modification can be made by those skilled in the art. Therefore, the present invention is not limited to the particular embodiments disclosed and described above, and the modifications and changes to the present invention are also intended to fall within the scope defined by the claims of the present invention. Furthermore, although some specific terms are used in the description, these terms are used for the purpose of illustration, rather than imposing any limitation to the present invention.

1. A cathode electrode for lithium-ion secondary battery, comprising:
a current collector; and
a cathode material layer comprising:
a bottom layer coated on the current collector; and
a top layer coated on the bottom layer,
wherein the lithium-ion transfer resistance of the active material particles in the bottom layer is smaller than that of the active material particles in the top layer.

2. The cathode electrode for lithium secondary battery according to claim 1, wherein the active material in the top layer and the active material in the bottom layer are of the same kind.

3. The cathode electrode for lithium secondary battery according to claim 1, wherein the bottom layer is consisted of an active material, a conductive carbon, and a binder, wherein the active material is surface coated with a coating material; and the top layer is consisted of an active material, a conductive carbon, and a binder, wherein the active material is surface coated with a coating material different from that for the active material in the bottom layer.

4. The cathode electrode for lithium secondary battery according to claim 3, wherein the active material in the bottom layer is surface coated with 0.01%-5% zirconia by mass percentage; and the active substance in the top is surface coated with one or more of aluminum oxide, magnesium oxide, zinc oxide, and manganese dioxide by a mass percentage of 0.01%-5%.

5. The cathode electrode for lithium secondary battery according to claim 1, wherein both the active material in the top layer and the active material of the bottom layer are surface coated with the same cladding material, and the mass percentage of the cladding material for the top layer is larger that that of the cladding material for the bottom layer.

6. The cathode electrode for lithium secondary battery according to claim 5, wherein the cladding material is one or more of aluminum oxide, magnesium oxide, zinc oxide, and manganese dioxide, wherein the mass percentage of the cladding material for the top layer is 0.02%-10%, and the mass percentage of the cladding material for the bottom layer is 0.01%-5%.

7. The cathode electrode for lithium secondary battery according to claim 1, wherein the active material in the bottom layer is not surface coated with a metal oxide, and the active material in the top layer is surface coated with metal oxides which are one or more of aluminum oxide, magnesium oxide, zinc oxide, and manganese dioxide, wherein the cladding material for the top layer has a mass percentage of 0.01%-10%.

8. The cathode electrode for lithium secondary battery according to claim 1, wherein the active material in the bottom layer is surface coated with 0.05% zirconium oxide by mass percentage; and the active material in the top layer is surface coated with 0.6% aluminum oxide by mass percentage.

9. The cathode electrode for lithium secondary battery according to claim 1, wherein the bottom layer has a thickness of 5-105 microns, and the top layer has a thickness of 5-105 microns.

10. A lithium-ion secondary batter, comprising a battery container, a electrode assembly, and an electrolyte, the electrode assembly and the electrolyte sealed in the battery container, and the electrode assembly comprising a cathode, an anode and a separator membrane disposed between the cathode and the anode, wherein the cathode is the cathode electrode for lithium-ion secondary battery according claim 1.
